(19) United States
(12) Patent Application Publication
(10) Pub. No.: US 2024/0380010 A1
(43) Pub. Date: Nov. 14, 2024

(54) BATTERY AND JOINING METHOD

(71) Applicant: Panasonic Intellectual Property Management Co., Ltd., Osaka (JP)

(72) Inventors: Yusuke MORIYAMA, Osaka (JP); Tomoaki SHINOBU, Osaka (JP); Shunsuke UEGAKI, Nara (JP); Takayuki HIROSE, Osaka (JP)

(21) Appl. No.: 18/692,768

(22) PCT Filed: Jul. 15, 2022
(86) PCT No.: PCT/JP2022/027848

§ 371 Date: Mar. 15, 2024

(30) Foreign Application Priority Data
Sep. 21, 2021 (JP) 2021-152940

(51) Int. Cl. H01M 10/0587

(52) U.S. Cl. CPC H01M 10/0587

(57) ABSTRACT

A battery includes a winding electrode group formed by stacking and winding a separator and an electrode plate; and a current collector plate. The electrode group is configured in such a manner that ends of a plurality of electrode plates arranged in a radial direction are bent in the radial direction, and a plurality of bent ends are joined to the current collector plate. The bent end includes a first region bent toward one side in the radial direction and a second region bent from a leading edge of the first region toward the other side in the radial direction.

### CROSS-REFERENCE TO RELATED APPLICATIONS

This application is based upon and claims the benefit of priority from the prior Japanese Patent Application No. 2021-152940, filed on Sep. 21, 2021, and the International Patent Application No. PCT/JP2022/027848, filed on Jul. 15, 2022, the entire content of each of which is incorporated herein by reference.

### BACKGROUND

### Field of the Invention

The present disclosure relates to a battery including an electrode group and a current collector plate and a method of joining an electrode group and a current collector plate.

### Description of the Related Art

Conventionally, a battery in which a winding electrode group and an electrolytic solution are housed in a cylindrical outer can is known. In connection with such a battery, PATENT LITERATURE 1 discloses a method of bending the end of the electrode group to form a flat welding surface and welding the welding surface and the current collector plate.

### PATENT LITERATURE 1: JP2015-106613

In the case the end of the electrode is bent, an excessive load may be applied to the root of the end when the current collector plate is pressed against the end. When a force is applied to the root of the end, exfoliation of the electrode active material layer or the like may occur, which could possibly result in a decrease in battery quality.

### SUMMARY OF THE INVENTION

The present disclosure addresses the issue described above, and a purpose thereof is to provide a technology for improving the quality of batteries.

An embodiment of the present disclosure relates to a battery. The battery includes: a winding electrode group formed by stacking and winding a separator and an electrode plate; and a current collector plate. The electrode group is configured in such a manner that ends of a plurality of electrode plates arranged in a radial direction are bent in the radial direction, and a plurality of bent ends are joined to the current collector plate. The bent end includes a first region bent toward one side in the radial direction and a second region bent from a leading edge of the first region toward the other side in the radial direction.

Another embodiment of the present disclosure relates to a method of joining a winding electrode group formed by stacking and winding a separator and an electrode plate to a current collector plate. The method includes: pressing a roller rotatable in a radial direction of the electrode group against ends of a plurality of electrode plates arranged in the radial direction, displacing the roller toward one side in the radial direction to bend a plurality ends toward the one side, and rotating the roller in such a manner as to displace a portion of the roller in contact with the end toward the other side in the radial direction, thereby bending a leading edge of the plurality of ends toward the other side; and joining the plurality of ends that are bent with the current collector plate.

Optional combinations of the aforementioned constituting elements, and implementations of the disclosure in the form of methods, apparatuses, and systems may also be practiced as additional aspects of the present disclosure.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional view of a battery;

FIG. 2A shows a step of forming the electrode group;

FIG. 2B shows a step of working the electrode group;

FIGS. 3A, 3B and 3C show how the end of the electrode group is deformed in the step of working the electrode group; and

FIG. 4 shows an appearance of the electrode group and the current collector plate joined.

### DETAILED DESCRIPTION OF THE INVENTION

Hereinafter, the present disclosure will be described based on preferred embodiments with reference to drawings. The embodiments do not limit the scope of the present disclosure but exemplify the disclosure. Not all of the features and the combinations thereof described in the embodiments are necessarily essential to the present disclosure. Identical or like constituting elements, members, processes shown in the drawings are represented by identical symbols and a duplicate description will be omitted as appropriate.

The scales and shapes shown in the figures are defined for convenience's sake to make the explanation easy and shall not be interpreted limitatively unless otherwise specified. Terms like “first”, “second”, etc. used in the specification and claims do not indicate an order or importance by any means unless otherwise specified and are used to distinguish a certain feature from the others. Those of the members that are not material to the description of the embodiments are omitted in the drawings.

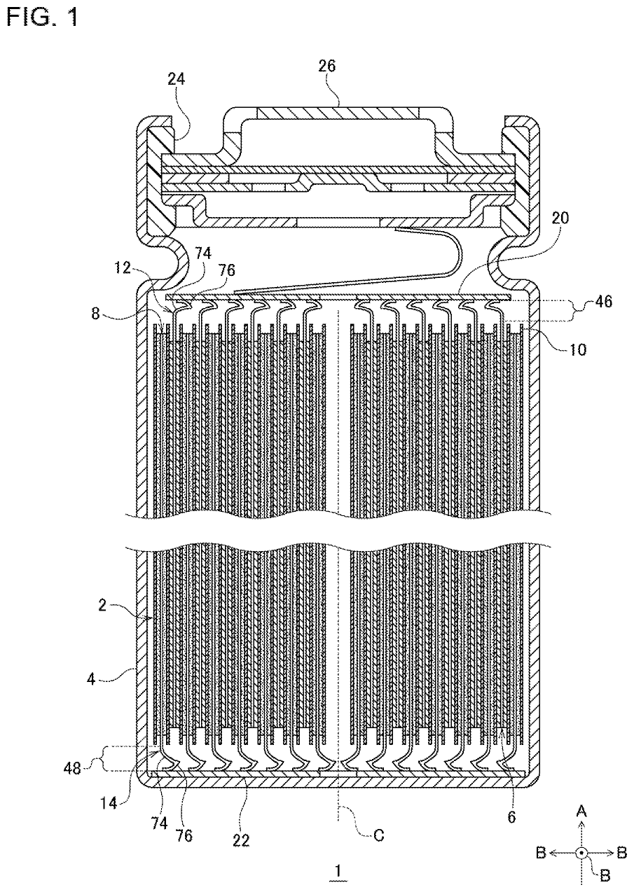

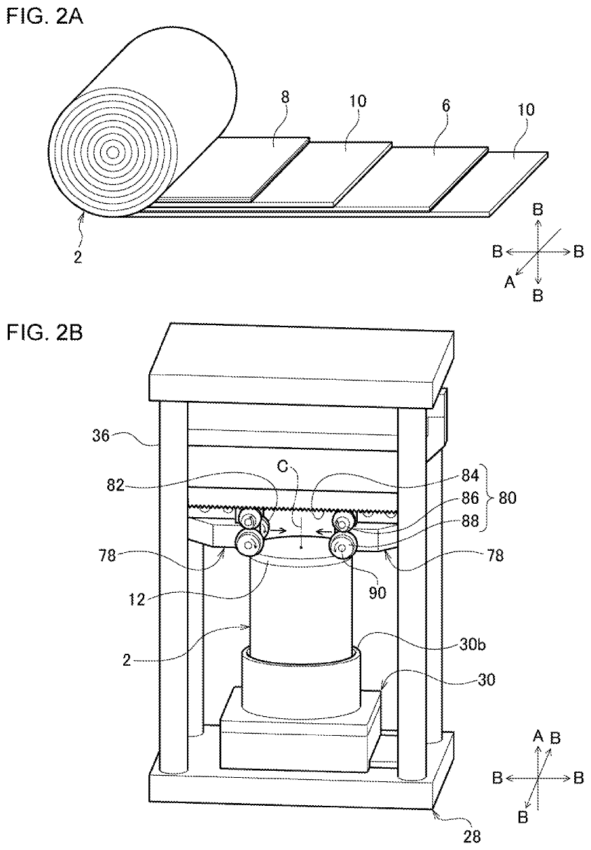

FIG. 1 is a cross-sectional view of a battery 1. The battery 1 is, for example, a rechargeable secondary battery such as a lithium ion battery, a nickel-metal hydride battery, and a nickel-cadmium battery. The battery 1 by way of one example has a structure in which the electrode group 2 is stored in an outer can 4 along with a electrolytic solution (not shown). The electrode group 2 is cylindrical in shape by way of one example and has a winding structure in which a belt-like first electrode plate 6 and a belt-like second electrode plate 8 are stacked, sandwiching a belt-like separator 10, and are wound in a spiral shape (see also FIG. 2A). In this embodiment, the first electrode plate 6 is the positive electrode plate and the second electrode plate 8 is the negative electrode plate. The separator 10 is formed by a microporous film made of, by way of one example, a polypropylene resin or the like.

The first electrode plate 6 and the second electrode plate 8 have a structure in which an electrode active material layer is stacked on a current collector. In the case of a general lithium ion secondary battery, the current collector is comprised of an aluminum foil or the like when it is a positive electrode and is comprised of a copper foil or the like when it is a negative electrode. The electrode active material layer can be formed by applying an electrode mixture material to the surface of the current collector by a known coating apparatus and drying and rolling the material. The electrode mixture material is obtained by kneading materials including an electrode active material, a binder, a conductive material, etc. in a dispersion medium and uniformly dispersing the materials. In the case of a general lithium ion secondary battery, the electrode active material is lithium cobalt oxide, lithium iron phosphate, or the like when it is a positive electrode and is graphite or the like when it is a negative electrode.

The first electrode plate 6 has a first uncoated portion 12 that is not coated with an electrode mixture material at the end on one side in the width direction A (a direction that intersects the longitudinal direction of the belt). The first uncoated portion 12 is an exposed portion in the current collector of the first electrode plate 6 where the electrode active material layer is not stacked. Further, the second electrode plate 8 has a second uncoated portion 14 not coated with an electrode mixture material at the end on the other side in the width direction A, that is, at the end opposite to the side where the first uncoated portion 12 protrudes. The second uncoated portion 14 is an exposed portion in the current collector of the second electrode plate 8 where the electrode active material layer is not stacked.

As described above, the electrode group 2 has a structure in which the first electrode plate 6 and the second electrode plate 8 are wound. For this reason, a plurality of ends of the first electrode plate 6 and the second electrode plate 8 in the width direction A are arranged in the radial direction B of the electrode group 2. Therefore, the electrode group 2 includes a plurality of first uncoated portions 12 arranged in the radial direction B and a plurality of second uncoated portions 14 arranged in the radial direction B.

The electrode group 2 has a first joined region 46 in which the ends of a plurality of first electrode plates 6 arranged in the radial direction B, i.e., the first uncoated portions 12, are bent in the radial direction B. The electrode group 2 by way of one example has a plurality of first joined regions 46 at predetermined spacings in the circumferential direction of the electrode group 2. For example, the electrode group 2 has four first joined regions 46 spaced at spacings of 90° in the circumferential direction. Similarly, the electrode group 2 has a second joined region 48 in which the ends of a plurality of second electrode plates 8 arranged in the radial direction B, i.e., the second uncoated portions 14, are bent in the radial direction B. The electrode group 2 by way of one example has a plurality of second joined regions 48 at predetermined spacings in the circumferential direction of the electrode group 2. For example, the electrode group 2 has four second joined regions 48 spaced at spacings of 90° in the circumferential direction.

By providing the first joined region 46 and the second joined region 48 in selected regions of the electrode group 2 in the circumferential direction, flexure in the circumferential direction caused by bending the respective uncoated portions can be absorbed by regions that not bent. This improves the quality of welding the electrode group 2 and the current collector plate and improves battery quality. It should be noted that the electrode group 2 may include only one of the first joined regions 46 and the second joined regions 48.

Each end of the first electrode plate 6 bent in the first joined region 46 includes a first region 74 and a second region 76. The first region 74 is bent toward one side in the radial direction B, and the second region 76 is bent from the leading edge of the first region 74 toward the other side in the radial direction B. Each end of the second electrode plate 8 bent in the second joined region 48 also includes the first region 74 and the second region 76. The first region 74 is bent toward one side in the radial direction B, and the second region 76 is bent from the leading edge of the first region 74 toward the other side in the radial direction B. Only one of the first uncoated portion 12 and the second uncoated portion 14 may include the first region 74 and the second region 76.

In this embodiment, one side in the radial direction B lies inward in the radial direction B, and the other side in the radial direction B lies outward in the radial direction B. In other words, the first region 74 is bent toward the center of winding C of the electrode group 2 in an area more toward the center in the width direction A than the second region 76. The center of winding C is, for example, the geometric center of the outline of the electrode group 2 seen in the width direction A, i.e., the geometric center of the outline of the shape of the electrode group 2 projected in the width direction A. The second region 76 is bent and extends outward in the radial direction B from the outer end of the first region 74 in the width direction A. It should be noted that “toward one side in the radial direction B” may be defined as outward in the radial direction B, and “toward the other side in the radial direction B” may be defined as inward in the radial direction B.

A first current collector plate 20 is provided on the side where the first uncoated portion 12 in the electrode group 2 protrudes. The first current collector plate 20 is made of, for example, aluminum or the like. The ends of the plurality of first electrode plates 6 bent in the first joined region 46 are placed in surface contact with the first current collector plate 20. By bending the end of each first electrode plate 6, the contact area between each first uncoated portion 12 and the first current collector plate 20 increases. Then, laser welding or the like is performed at a position where the first joined region 46 and the first current collector plate 20 overlap. Thereby, the first electrode plate 6 of each winding layer and the first current collector plate 20 are joined to each other. At the end of first electrode plate 6, the second region 76 is mainly joined to the first current collector plate 20.

A second current collector plate 22 is provided on the side where the second uncoated portion 14 in the electrode group 2 protrudes. The second current collector plate 22 is made of, for example, copper, nickel, nickel-plated copper, nickel-plated iron, and the like. The ends of a plurality of second electrode plates 8 bent in the second joined region 48 are in surface contact with the second current collector plate 22. By bending the end of each second electrode plate 8, the contact area between each second uncoated portion 14 and the second current collector plate 22 increases. Laser welding or the like is performed at a position where the second joined region 48 and the second current collector plate 22 overlap. Thereby, the second electrode plate 8 of each winding layer and the second current collector plate 22 are joined to each other. At the end of second electrode plate 8, the second region 76 is mainly joined to the second current collector plate 22.

The electrode group 2 to which the first current collector plate 20 and the second current collector plate 22 are joined is stored in the bottomed cylindrical outer can 4 along with the electrolytic solution. The outer can 4 is made of, for example, copper, nickel, iron, an alloy thereof, or the like. The second current collector plate 22 is joined to the inner bottom surface of the outer can 4 by welding or the like. The first current collector plate 20 is joined to a sealing plate 26 made of the same metal as the outer can 4 by welding or the like. The sealing plate 26 is fitted into the opening of the outer can 4 via an insulating gasket 24. Thereby, the electrode group 2 and the electrolytic solution are sealed in the outer can 4.

The method of joining the electrode group 2 and the current collector plate will now be described. Hereinafter, the method of joining the electrode group 2 and the current collector plate will be described with reference to joint between the first joined region 46 and the first current collector plate 20 as an example. Joint between the second joined region 48 and the second current collector plate 22 is the same as in the case of the first joined region 46. It should be noted that only one of the first joined regions 46 and the second joined regions 48 may be formed and joined to the current collector plate by the method according to this embodiment.

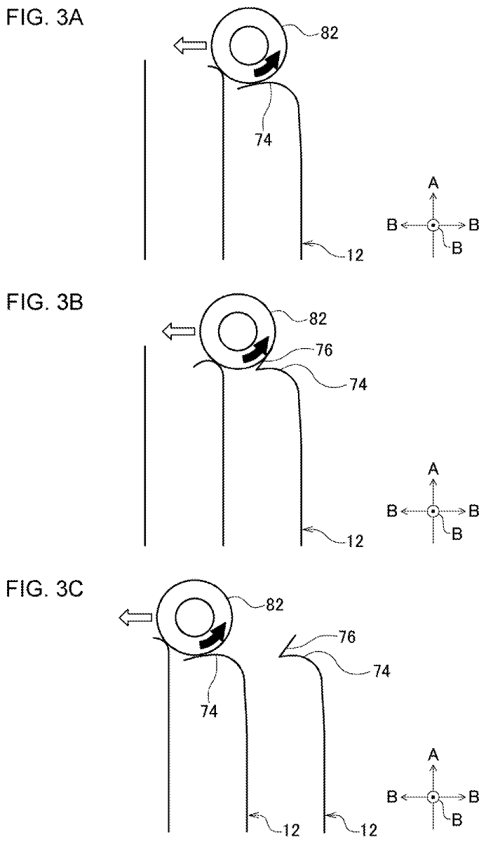

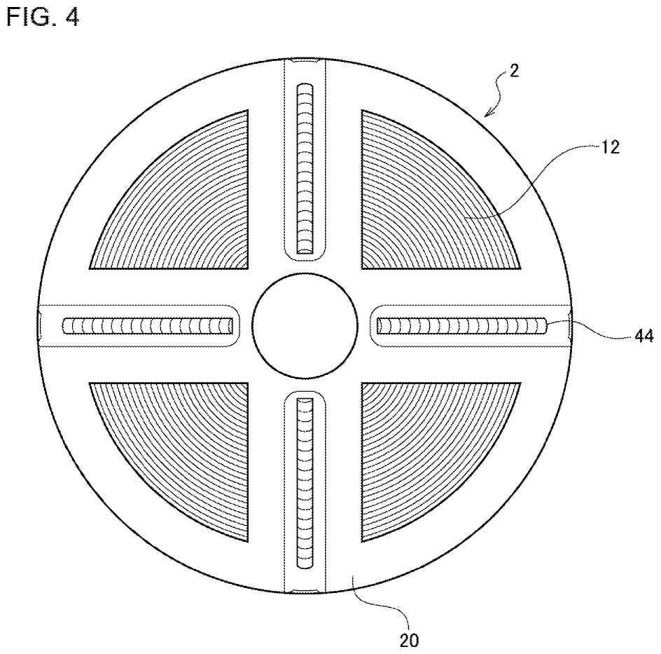

FIG. 2A shows a step of forming the electrode group 2. In FIG. 2A, illustration of a first uncoated portion 12 and a second uncoated portion 14 is omitted. FIG. 2B shows a step of working the electrode group 2. FIGS. 3A-3C show how the end of the electrode group 2 is deformed in the step of working the electrode group 2. FIG. 4 shows an appearance of the electrode group 2 and the current collector plate joined.

First, as shown in FIG. 2A, the first electrode plate 6, the second electrode plate 8, and the separators 10, which are belt-like, are prepared. Then, the separator 10, the first electrode plate 6, the separator 10, and the second electrode plate 8 are stacked in this order. The stacked product thus obtained is wound in a spiral shape to form the winding electrode group 2.

Then, as shown in FIG. 2B, the electrode group 2 is set in a processing machine 28. The processing machine 28 includes a stage 30, a pair of processing tools 78, a roller rotation mechanism 80, and a frame 36. The stage 30 by way of one example has a circular groove 30b in which the end of the electrode group 2 is fitted, and the electrode group 2 is fixed as the end is fitted in the groove 30b. The method of fixing the electrode group 2 is not particularly limited. The attitude of the electrode group 2 is determined such that the center of winding C extends in the normal direction of the stage 30. The attitude of the electrode group 2 shown in FIG. 2B is determined such that the first uncoated portion 12 faces away from the stage 30. The stage 30 is structured to rotate the electrode group 2 about the center of winding C.

A pair of processing tools 78 are disposed at positions opposite to the stage 30 across the electrode group 2. Each processing tool 78 is supported by the frame 36 such that the processing tool 78 can be slid in the radial direction B. Further, the frame 36 supports a drive unit (not shown) that slides each processing tool 78 in the radial direction B. The drive unit can be configured by, for example, a motor, a cam mechanism, etc. Each processing tool 78 has a roller 82 that faces the electrode group 2. Each roller 82 is supported by each processing tool 78 such that the roller 82 is rotatable in the radial direction B. Each roller 82 is pressed against the ends of a plurality of electrode plates (the first uncoated portions 12 in FIG. 2B).

The roller rotation mechanism 80 is supported by the frame 36. The roller rotation mechanism 80 by way of one example is configured with the same mechanism as rack and pinion and has a rack rail 84, a first pinion 86, and a second pinion 88. The rack rail 84 is supported by the frame 36 and extends in the radial direction B. The first pinion 86 is in mesh with the rack rail 84 and is supported by the processing tool 78. The second pinion 88 is in mesh with the first pinion 86 and is supported by the processing tool 78. The second pinion 88 and the roller 82 are connected by a rotation shaft 90 extending in a direction perpendicular to the radial direction B. When the second pinion 88 rotates, a torque is transmitted to the roller 82 via the rotation shaft 90, rotating the roller 82. In this embodiment, the first pinion 86 and the second pinion 88 are provided for the roller 82 of each processing tool 78, and the rack rail 84 is common to the rollers 82.

Each processing tool 78 slides toward one side in the radial direction B while the roller 82 is being pressed against the plurality of first uncoated portions 12 arranged in the radial direction B. Thereby, the entire roller 82 is displaced toward one side in the radial direction B. In addition, each roller 82 rotates such that a portion of the roller 82 in contact with the end (the first uncoated portion 12 in FIG. 2B) of the electrode plate, i.e., the portion of the roller 82 facing the stage 30, is displaced toward the other side in the radial direction B.

By way of one example, the roller 82 is pressed against the first uncoated portion 12, with each processing tool 78 being located at the outermost end in the radial direction B. Each processing tool 78 then slides inward in the radial direction B. This displaces the entire roller 82 inward in the radial direction B. As shown in FIG. 3A, this displacement of the roller 82 bends the end of the first uncoated portion 12 inward to form the first region 74.

The first pinion 86 and the second pinion 88 supported by each processing tool 78 are also displaced inward in the radial direction B along with the roller 82. In concurrence with this, the first pinion 86 moves along the rack rail 84 and rotates by meshing with the rack rail 84. The first pinion 86 rotates such that the portion facing the stage 30 is displaced inward in the radial direction B. The second pinion 88 rotates by meshing with the first pinion 86. The second pinion 88 rotates in the direction opposite to that of the first pinion 86, i.e., such that the portion facing the stage 30 is displaced outward in the radial direction B. The rotational torque of the second pinion 88 is transmitted to the roller 82 via the rotation shaft 90, which also rotates the roller 82.

Each roller 82 rotates such that a portion of the roller 82 in contact with the first uncoated portion 12, i.e., the portion of the roller 82 facing the stage 30, is displaced outward in the radial direction B. Friction is created between the circumferential surface of the roller 82 and the first uncoated portion 12. Therefore, the rotation of the roller 82 bends the leading edge of the first uncoated portion 12 outward in the radial direction B and forms the second region 76 at the leading edge of the first region 74, as shown in FIG. 3B.

Each roller 82 is rotated at a speed faster than when the entire roller 82 is driven by way of contact with the ends of the plurality of electrode plates when displaced by the sliding motion of the processing tool 78 toward one side in the radial direction B. This makes it easier to raise the leading edge of the first region 74. Preferably, the roller 82 is made of a resin. This increases a frictional force on the first uncoated portion 12 and the second uncoated portion 14 that are made of a metal. It is therefore easy to form the second region 76. Examples of the resin constituting the roller 82 include urethane.

Active rotation of the roller 82 like this can be realized by adjusting the reduction ratio (gear ratio) of the rack rail 84, the first pinion 86, and the second pinion 88. When the roller rotation mechanism 80 is not provided, each roller 82 is driven by way of friction with the first uncoated portion 12 to rotate concurrently with the sliding motion of the processing tool 78. Denoting the rotation speed of the roller 82 in this case (the amount of rotation of the roller 82 per unit displacement of the processing tool 78) by 1, the roller rotation mechanism 80 rotates the roller 82 such that the rotation speed is greater than 1 (e.g., 1.25 or more).

Subsequently, as shown in FIG. 3C, each processing tool 78 slides further inward in the radial direction B, forming the first region 74 in the adjacent first uncoated portion 12. Thereafter, this operation is repeated, and the first region 74 and the second region 76 are formed at the leading edge of the first uncoated portions 12 over the entirety in the radial direction B. In other words, each first uncoated portion 12 is pressed along a straight line through the center of winding C as seen in the direction of extension of the center of winding C, the first region 74 and the second region 76 are formed accordingly. The above step is defined as the first stage in the processing steps. In the second stage, the electrode group 2 is rotated 90° about the center of winding C, and the pair of processing tools 78 press each uncoated portion 12 again along a straight line through the center of winding C. Thereby, the first joined regions 46 are formed in the electrode group 2 in a crisscross pattern.

After the first joined regions 46 are formed, the first current collector plate 20 is pressed against the electrode group 2. Then, as shown in FIG. 4, laser welding or the like is performed at a position where the first joined region 46 and the first current collector plate 20 overlap to form a joined portion 44. Thereby, the plurality of first uncoated portions 12 bent in the first joined region 46 and the first current collector plate 20 are joined. The electrode group 2 to which the first current collector plate 20 is joined is oriented such that the second uncoated portion 14 faces away from the stage 30 and is fixed to the stage 30 accordingly. Then, the second uncoated portion 14 is subject to the above-described processing steps by the pair of processing tools 78. As a result, the second joined regions 48 are formed in the electrode group 2 in a crisscross pattern. Then, the plurality of second uncoated portions 14 bent in the second joined region 48 and the second current collector plate 22 are joined by laser welding, etc.

The electrode group 2 to which the first current collector plate 20 and the second current collector plate 22 are joined is stored in the outer can 4 along with the electrolytic solution. Further, processes like joint of the second current collector plate 22 with the outer can 4, joint of the first current collector plate 20 with the sealing plate 26, fitting of the sealing plate 26 to the opening of the outer can 4, etc. are performed. The battery 1 is obtained accordingly. Then, the sequence of steps like joint of respective parts, storage in the outer can 4, and fitting of the sealing plate 26 can be modified as appropriate. In the case a liquid pouring port is provided in the sealing plate 26, etc., the electrolytic solution may be poured into the outer can 4 after the sealing plate 26 is fitted in the opening of the outer can 4.

As described above, the electrode group 2 included in the battery 1 according to this embodiment is configured in such a manner that the ends of a plurality of electrode plates arranged in the radial direction B are bent in the radial direction B, and the plurality of bent ends are joined to the current collector plate. The bent end has a first region 74 bent toward one side in the radial direction B and a second region 76 bent from the leading edge of the first region 74 toward the other side in the radial direction B.

When a current collector plate is joined to the end of the electrode plate, a load is applied to the end of the electrode plate when the current collector plate is pressed against the electrode group 2. When the end of the electrode plate includes only the first region 74, the load may be concentrated in the portion of the electrode plate where the electrode active material layer is stacked, which could create buckling in that portion and induce exfoliation of the electrode active material layer, etc. In this embodiment, on the other hand, the second region 76 that is folded toward the opposite side is provided at the leading edge of the first region 74, and the current collector plate is pressed against the second region 76. This causes the load applied to the electrode plate when the current collector plate is pressed against thereto to be concentrated in a region including a portion where the first region 74 and the second region 76 are connected. As a result, exfoliation of the electrode active material layer, etc. is suppressed, and the quality of the battery 1 is improved.

Further, in the present embodiment, the first region 74 is folded inward in the radial direction B, and the second region 76 is folded outward in the radial direction B. This makes it possible to form the first region 74 and the second region 76 more easily and stably than when the first region 74 is folded outward and the second region 76 is folded inward, respectively. Accordingly, the stability of joint between the electrode plate in each winding layer and the current collector plate is increased, and the quality of the battery 1 is improved.

Further, the method of joining the electrode group 2 and the current collector plate according to this embodiment includes: pressing the roller 82 rotatable in the radial direction B against the ends of the plurality of electrode plates, displacing the roller 82 toward one side in the radial direction B to bend a plurality ends toward one side, rotating the roller 82 in such a manner as to displace a portion of the roller 82 in contact with the end of the electrode plate toward the other side in the radial direction B so as to bend the leading edge of the plurality of ends toward the other side, and joining the plurality of ends that are bent with the current collector plate.

By sliding the roller 82 in the radial direction B while pressing the roller 82 against the end of the electrode plate, the first region 74 is formed at the end of the electrode plate. Further, by rotating the roller 82 concurrently with the sliding motion, the second region 76 is formed at the leading edge of the first region 74. According to this embodiment, therefore, the first region 74 and the second region 76 are easily formed at the end of the electrode plate.

Further, the roller 82 is rotated at a speed faster than when the roller 82 is driven by way of contact with the ends of the plurality of electrode plates when displaced toward one side in the radial direction B. This makes it easier to fold back the leading edge of the first region 74. It is therefore easier to form the second region 76 so that the quality of the battery 1 is improved. Further, the roller 82 is made of a resin. This increases a frictional force on the uncoated portion, which is made of a metal foil, as compared with the case where the roller 82 is made of a metal and makes it easier to form the second region 76. Accordingly, the quality of the battery 1 is improved.

The embodiments of the present disclosure are described above in detail. The embodiments described above are merely specific examples of practicing the present disclosure. The details of the embodiment shall not be construed as limiting the technical scope of the present disclosure. A number of design modifications such as modification, addition, deletion, etc. of constituting elements may be made to the extent that they do not depart from the idea of the invention defined by the claims. New embodiments with design modifications will provide the combined advantages of the embodiment and the variation. Although the details subject to such design modification are emphasized in the embodiment described above by using phrases such as “of this embodiment” and “in this embodiment”, details not referred to as such are also subject to design modification. Any combination of constituting elements included in the respective embodiments is also useful as an embodiment of the present disclosure. Hatching in the cross section in the drawings should not be construed as limiting the material of the hatched object.

The embodiments may be defined by the following items.

### ITEM 1

A battery (1) including:

a winding electrode group (2) formed by stacking and winding a separator (10) and an electrode plate (6, 8); and

a current collector plate (20, 22),

wherein the electrode group (2) is configured in such a manner that ends of a plurality of electrode plates (6, 8) arranged in a radial direction (B) are bent in the radial direction (B), and a plurality of bent ends are joined to the current collector plate (20, 22),

wherein the bent end includes a first region (74) bent toward one side in the radial direction (B) and a second region (76) bent from a leading edge of the first region (74) toward the other side in the radial direction (B).

### ITEM 2

The battery (1) according to ITEM 1,

wherein one side lies inward in the radial direction (B), and

wherein the other side lies outward in the radial direction (B).

### ITEM 3

A method of joining a winding electrode group (2) formed by stacking and winding a separator (10) and an electrode plate (6, 8) to a current collector plate (20, 22), including:

pressing a roller (82) rotatable in a radial direction (B) of the electrode group (2) against ends of a plurality of electrode plates (6, 8) arranged in the radial direction (B), displacing the roller (82) toward one side in the radial direction (B) to bend a plurality ends toward the one side, and rotating the roller (82) in such a manner as to displace a portion of the roller (82) in contact with the end toward the other side in the radial direction (B), thereby bending a leading edge of the plurality of ends toward the other side; and

joining the plurality of ends that are bent with the current collector plate (20, 22).

### ITEM 4

The method of joining according to ITEM 3,

wherein the roller (82) is rotated at a speed faster than when the roller (82) is driven by way of contact with the ends when displaced toward the one side.

### ITEM 5

The method of joining according to ITEM 3 or 4,

wherein the end of the electrode plate (6, 8) is made of a metal, and

wherein the roller (82) is made of a resin.

1. A battery comprising:
a winding electrode group formed by stacking and winding a separator and an electrode plate; and
a current collector plate,
wherein the electrode group is configured in such a manner that ends of a plurality of electrode plates arranged in a radial direction are bent in the radial direction, and a plurality of bent ends are joined to the current collector plate,
wherein the bent end includes a first region bent toward one side in the radial direction and a second region bent from a leading edge of the first region toward the other side in the radial direction.

2. The battery according to claim 1,
wherein one side lies inward in the radial direction, and
wherein the other side lies outward in the radial direction.

3. A method of joining a winding electrode group formed by stacking and winding a separator and an electrode plate to a current collector plate, comprising:
pressing a roller rotatable in a radial direction of the electrode group against ends of a plurality of electrode plates arranged in the radial direction, displacing the roller toward one side in the radial direction to bend a plurality ends toward the one side, and rotating the roller in such a manner as to displace a portion of the roller in contact with the end toward the other side in the radial direction, thereby bending a leading edge of the plurality of ends toward the other side; and
joining the plurality of ends that are bent with the current collector plate.

4. The method of joining according to claim 3,
wherein the roller is rotated at a speed faster than when the roller is driven by way of contact with the ends when displaced toward the one side.

5. The method of joining according to claim 3,
wherein the end of the electrode plate is made of a metal, and
wherein the roller is made of a resin.
